(19) United States
(12) Patent Application Publication
(10) Pub. No.: US 2018/0363174 A1
(43) Pub. Date: Dec. 20, 2018

(54) SHEET MEMBER AND METHOD FOR MANUFACTURING SHEET MEMBER

(71) Applicant: SUMITOMO WIRING SYSTEMS, LTD., Mie (JP)

(72) Inventors: Akihide KONDO, Mie (JP); Masamichi YAMAGIWA, Mie (JP); Takeshi HIROSE, Mie (JP); Masahiro MIZUTANI, Mie (JP)

(73) Assignee: SUMITOMO WIRING SYSTEMS, LTD., Mie (JP)

(21) Appl. No.: 16/062,271

(22) PCT Filed: Dec. 27, 2016
(86) PCT No.: PCT/JP2016/088827

§ 371 Date: Jun. 14, 2018

(30) Foreign Application Priority Data
Jan. 15, 2016 (JP) 2016-006041

(51) Int. Cl. D03D 15/02

(52) U.S. Cl. CPC D03D 15/02; H01B 7/0045; D10B 2101/20; D03D 2700/0174

(57) ABSTRACT

An object of the invention is to provide a technique for even more firmly joining metal threads of a metal fabric together. A sheet member is formed from a metal fabric that is woven from metal warp threads and metal weft threads such that the metal warp threads and the metal weft threads alternately cross each other, the metal warp threads and the metal weft threads individually including a linear metal strand made of a metal and a coating portion that covers a circumference of the metal strand. The sheet member includes a welded portion where the coating portions of the metal warp threads and the coating portions of the metal weft threads are joined together at crossing portions of the metal warp threads and the metal weft threads.

### TECHNICAL FIELD

The present invention relates to a sheet member formed from a metal fabric and a method for manufacturing the same.

### BACKGROUND ART

As disclosed in Patent Document 1, for example, there are cases where a metal fabric, which is a woven fabric made of metal threads, is used as a shielding member for wires, of a wire harness.

### CITATION LIST

### Patent Documents

Patent Document 1: JP 2014-123623A

### SUMMARY OF INVENTION

### Technical Problem

A metal fabric is formed by weaving metal threads. The metal threads constituting the metal fabric maintain a sheet-like shape due to friction between portions of the metal threads that are in contact with each other. It is thus desired to suppress fraying of the metal threads of the metal fabric. That is to say, it is desired to even more firmly join the metal threads of the metal fabric together.

An object of the present invention is to provide a technique for even more firmly joining metal threads of a metal fabric together.

### Solution to Problem

A sheet member according to a first aspect is formed from a metal fabric that is woven from metal warp threads and metal weft threads such that the metal warp threads and metal weft threads alternately cross each other, the metal warp threads and the metal weft threads individually including a linear metal strand made of a metal and a coating portion that covers a circumference of the metal strand, and includes a welded portion where the coating portions of the metal warp threads and the coating portions of the metal weft threads are welded together at crossing portions of the metal warp threads and the metal weft threads.

A sheet member according to a second aspect is a form of the sheet member according to the first aspect. In the sheet member according to the second aspect, the welded portion is provided at an outer edge portion.

A sheet member according to a third aspect is a form of the sheet member according to the second aspect. The sheet member according to the third aspect further includes four straight line-shaped outer edge portions, wherein the welded portion is formed at two opposing outer edge portions of the four outer edge portions of the metal fabric.

A sheet member according to a fourth aspect is a form of the sheet member according to any one of the first to third aspects. In the sheet member according to the fourth aspect, the welded portion is formed by performing welding at a temperature that is higher than a melting point of the coating portion and lower than a melting point of the metal strand.

A sheet member according to a fifth aspect is a form of the sheet member according to any one of the first to fourth aspects. In the sheet member according to the fifth aspect, a thickness of the welded portion is the same as a thickness of the metal warp threads alone and a thickness of the metal weft threads alone.

A sheet member according to a sixth aspect is a form of the sheet member according to any one of the first to fifth aspects. In the sheet member according to the sixth aspect, the metal strand is a strand made of a metal mainly composed of copper, and the coating portion is a tin plating layer that covers the metal strand.

A method for manufacturing a sheet member according to a seventh aspect is a method for manufacturing a sheet member formed from a metal fabric that is woven from metal warp threads and metal weft threads such that the metal warp threads and metal weft threads alternately cross each other, the metal warp threads and the metal weft threads individually including a linear metal strand made of a metal and a coating portion that covers a circumference of the metal strand, the method including a welding step of applying heat and pressure to crossing portions of the metal warp threads and the metal weft threads of the metal fabric to weld the coating portions of the metal warp threads and the metal weft threads together, thereby forming a welded portion, and a cutting step of cutting the metal fabric into a predetermined shape.

A method for manufacturing a sheet member according to an eighth aspect is a form of the method for manufacturing a sheet member according to the seventh aspect. In the method for manufacturing a sheet member according to the eighth aspect, in the cutting step, the metal fabric is cut at the welded portion to thereby obtain the sheet member.

A method for manufacturing a sheet member according to a ninth aspect is a form of the method for manufacturing a sheet member according to the seventh or eighth aspect. In the method for manufacturing a sheet member according to the ninth aspect, in the welding step, the welded portion is formed through heating at a temperature that is higher than a melting point of the coating portion and lower than a melting point of the metal strand.

### Advantageous Effects of Invention

In the above-described aspects, the sheet member includes the welded portion, where the coating portions of the metal warp threads and the metal weft threads are welded together at the crossing portions of the metal warp threads and the metal weft threads. In the sheet member in this case, the metal strands of the metal warp threads and the metal strands of the metal weft threads are joined together via the coating portions. Thus, the metal warp threads and the metal weft threads of the metal fabric can be even more firmly joined together.

According to the second aspect, the welded portion is provided at an outer edge portion of the metal fabric. In this case, the welded portion provided at the outer edge portion can suppress the spread of fraying of the metal warp threads and the metal weft threads.

According to the third aspect, the metal fabric includes the four straight line-shaped outer edge portions, and a welded portion is provided at two opposing outer edge portions of the four outer edge portions of the metal fabric. In this case, the shapes of the two outer edge portions at which the welded portions are formed are fixed, and the sheet member is therefore less likely to deform in a direction that crosses a direction in which the two outer edge portions oppose each other.

According to the fourth aspect, the welded portion is formed by performing welding at a temperature that is higher than the melting point of the coating portion and lower than the melting point of the metal strand. In this case, the metal strand in the welded portion is not completely melted, and thus the crossing shape of the metal warp threads and the metal weft threads is maintained. According to the fourth aspect, it is therefore possible to join the metal warp threads and the metal weft threads together via the coating portions while maintaining the shape of the metal strands of the metal warp threads and the metal weft threads.

According to the fifth aspect, the thickness of the welded portion is the same as the thickness of the metal warp threads alone and the thickness of the metal weft threads alone. In this case, the welded portion can be suppressed from becoming excessively thick compared with the other portions of the sheet member.

According to the sixth aspect, the metal strand is a strand made of a metal mainly composed of copper, and the coating portion is a tin plating layer that covers the metal strand. In this case, the metal strands of the metal warp threads and the metal weft threads can be joined together via the tin plating layers.

According to the seventh aspect, it is possible to manufacture the sheet member by joining the metal strands of the metal warp threads and the metal strands of the metal weft threads together via the coating portions. Therefore, the metal warp threads and the metal weft threads of the metal fabric can be even more firmly joined together.

According to the eighth aspect, the sheet member is obtained by cutting the metal fabric at the welded portion. Thus, fraying of the woven metal warp and weft threads during cutting can be suppressed.

According to the ninth aspect, in the welding step, the metal strands are not completely melted, and the crossing shape of the metal warp threads and the metal weft threads is thus maintained. Therefore, according to the ninth aspect, it is possible to join the metal warp threads and the metal weft threads together via the coating portions while maintaining the shape of the metal strands of the metal warp threads and the metal weft threads.

### BRIEF DESCRIPTION OF DRAWINGS

FIG. 1 is a plan view of a sheet member according to an embodiment.

FIG. 2 is a plan view of a wire harness including the sheet member according to the embodiment.

FIG. 3 is a cross-sectional view of a metal warp thread or a metal weft thread of the sheet member according to the embodiment.

FIG. 4 is an explanatory diagram illustrating a method for manufacturing a sheet member according to the embodiment.

FIG. 5 is an explanatory diagram illustrating the method for manufacturing a sheet member according to the embodiment.

FIG. 6 is an explanatory diagram illustrating the method for manufacturing a sheet member according to the embodiment.

FIG. 7 is an explanatory diagram illustrating the method for manufacturing a sheet member according to the embodiment.

FIG. 8 is an explanatory diagram illustrating the method for manufacturing a sheet member according to the embodiment.

FIG. 9 is an explanatory diagram illustrating the method for manufacturing a sheet member according to the embodiment.

FIG. 10 is a plan view of a sheet member according to a first modification.

FIG. 11 is an explanatory diagram illustrating a method for manufacturing a sheet member according to a second modification.

FIG. 12 is an explanatory diagram illustrating the method for manufacturing a sheet member according to the second modification.

FIG. 13 is a plan view of a sheet member according to the second modification.

### DESCRIPTION OF EMBODIMENTS

Hereinafter, an embodiment will be described with reference to the accompanying drawings. The embodiment below is merely an example of embodiments of the present invention and is not to be construed as limiting the technical scope of the invention.

### Embodiment

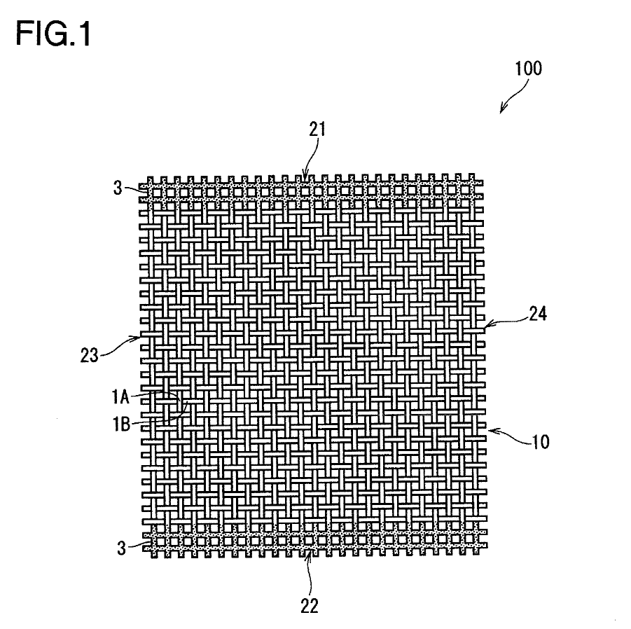

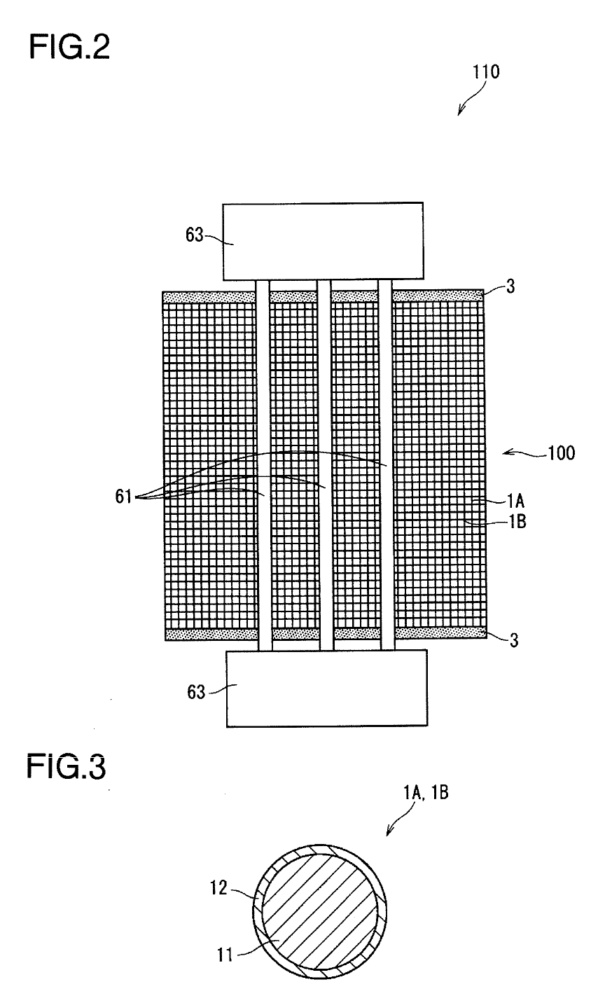

With reference first to FIGS. 1 to 3, a sheet member 100 according to an embodiment will be described. FIG. 1 is a plan view of the sheet member 100. FIG. 2 is a plan view of a wire harness 110 including the sheet member 100. FIG. 3 is a cross-sectional view of a metal warp thread 1A (metal weft thread 1B) included in the sheet member 100.

As shown in FIGS. 1 and 2, the sheet member 100 is formed from a metal fabric 10 that is woven from metal warp threads 1A and metal weft threads 1B such that the metal warp threads 1A and the metal weft threads 1B alternately cross each other.

Moreover, according to the present embodiment, the sheet member 100 has four straight line-shaped outer edge portions. Note that, as shown in FIG. 1, the outer edge portions of the sheet member 100 here include only four straight line-shaped outer edge portions, and are formed by a rectangular metal fabric 10 obtained by interlacing a plurality of metal warp threads 1A and a plurality of metal weft threads 1B in the manner of a cloth.

Note that a case where the straight line-shaped outer edge portions are connected to each other via an arc-shape portion, that is, a case where the sheet member 100 has a rounded rectangular shape is conceivable as another configuration. Moreover, cases where the sheet member 100 has a circular shape, an elliptical shape, a trapezoidal shape, a rounded rectangular shape, or a polygonal shape are also conceivable.

In the following description, the four outer edge portions will be respectively referred to as a first outer edge portion 21, a second outer edge portion 22, a third outer edge portion 23, and a fourth outer edge portion 24 as necessary. Note that, here, as shown in FIG. 1, the outer edge portion on the opposite side to the first outer edge portion 21 is the second outer edge portion 22, and the outer edge portion on the opposite side to the third outer edge portion 23 is the fourth outer edge portion 24. That is to say, in the sheet member 100, the first outer edge portion 21 and the second outer edge portion 22 oppose each other, and the third outer edge portion 23 and the fourth outer edge portion 24 oppose each other.

Moreover, according to the present embodiment, as shown in FIG. 1, each metal warp thread 1A extends in a direction in which the first outer edge portion 21 and the second outer edge portion 22 oppose each other. Also, the plurality of metal warp threads 1A are arranged in parallel in a direction in which the third outer edge portion 23 and the fourth outer edge portion 24 oppose each other. Moreover, according to the present embodiment, each metal weft thread 1B extends in the direction in which the third outer edge portion 23 and the fourth outer edge portion 24 oppose each other. Also, the plurality of metal weft threads 1B are arranged in parallel in the direction in which the first outer edge portion 21 and the second outer edge portion 22 oppose each other.

That is to say, here, the plurality of metal warp threads 1A and the plurality of metal weft threads 1B are woven together so as to perpendicularly cross each other to thereby form the metal fabric 10. Naturally, a case is also conceivable in which the metal warp threads 1A and the metal weft threads 1B are woven together so as to diagonally cross each other to thereby form the metal fabric 10.

Moreover, in the sheet member 100, the metal warp threads 1A and the metal weft threads 1B alternately cross each other. That is to say, when one of the main surfaces of the sheet member 100 (metal fabric 10) is referred to as a first main surface, and the other of the main surfaces is referred to as a second main surface, the metal warp threads 1A are woven in a state in which each metal warp thread 1A alternately passes the first main surface side and the second main surface side of the plurality of metal weft threads 1B that are arranged side-by-side in the direction in which the first outer edge portion 21 and the second outer edge portion 22 oppose each other. Similarly, the metal weft threads 1B are also woven in a state in which each metal weft thread 1B alternately passes the first main surface side and the second main surface side of the plurality of metal warp threads 1A that are arranged side-by-side in the direction in which the third outer edge portion 23 and the fourth outer edge portion 24 oppose each other. Note that, for example, a case is also conceivable in which the metal fabric 10 is formed in a state in which the metal warp threads 1A (metal weft threads 1B) do not alternately pass the first main surface side and the second main surface side of the plurality of metal weft threads 1B (metal warp threads 1A) that are arranged side-by-side, or in other words, the plurality of metal warp threads 1A and the plurality of metal weft threads 1B are irregularly woven together.

Moreover, as shown in FIG. 3, the metal warp threads 1A and the metal weft threads 1B of the sheet member 100 individually include a linear metal strand 11 that is made of a metal and a coating portion 12 that covers the circumference of the metal strand 11. The sheet member 100 includes welded portions 3 where the coating portions 12 of the metal warp threads 1A and the coating portions 12 of the metal weft threads 1B are welded together at crossing portions of the metal warp threads 1A and the metal weft threads 1B. More specifically, in the welded portions 3, the coating portions 12 of the metal warp threads 1A and the coating portions 12 of the metal weft threads 1B are melted and then solidified, thereby joining the metal strands 11 of the metal warp threads 1A and the metal strands 11 of the metal weft threads 1B together.

According to the present embodiment, the metal warp threads 1A and the metal weft threads 1B have the same thickness. Here, the welded portions 3 are formed by hot pressing the crossing portions of the metal warp threads 1A and the metal weft threads 1B as will be described later. The welded portions 3 are thus configured to have the same thickness as the thickness of the metal warp threads 1A alone and the thickness of the metal weft threads 1B alone. In this case, the sheet member 100 can be suppressed from having an excessively large thickness in the welded portions 3. Thus, the sheet member 100 is suppressed from, for example, becoming excessively hard to bend at the welded portions 3. Consequently, in the case where, for example, the sheet member 100 is used as a shielding member of the wire harness 110 as will be described later, the sheet member 100 can be disposed along the route of the wires.

Moreover, here, since the welded portions 3 are formed through hot pressing, it is believed that the first main surface and the second main surface in the welded portions 3 are constituted by flat surfaces.

Moreover, according to the present embodiment, the welded portions 3 are provided at outer edge portions of the sheet member 100. Here, as shown in FIG. 1, the welded portions 3 are respectively formed at the first outer edge portion 21 and the second outer edge portion 22.

More specifically, as shown in FIG. 1, a welded portion 3 is formed across the first outer edge portion 21, that is, a portion spanning from an end portion on the third outer edge portion 23 side to an end portion on the fourth outer edge portion 24 side, of the first outer edge portion 21. Similarly, a welded portion 3 is formed across the second outer edge portion 22, that is, a portion spanning from an end portion on the third outer edge portion 23 side to an end portion on the fourth outer edge portion 24 side, of the second outer edge portion 22. In this sheet member 100, as a result of forming the welded portions 3, the shapes of the first outer edge portion 21 and the second outer edge portion 22 are fixed. Thus, it is believed that the sheet member 100 is less likely to deform in, for example, a direction from the first outer edge portion 21 toward the second outer edge portion 22 such that the third outer edge portion 23 and the fourth outer edge portion 24 are shifted in opposite directions.

Here, the metal warp threads 1A and the metal weft threads 1B are each, for example, a metal-plated strand including a metal strand 11, which is a strand made of a metal, and a coating portion 12, which is a plating layer that covers the circumference of the metal strand 11. Hereinafter, a case in which the metal strands 11 are made of a metal mainly composed of copper, and the coating portions 12 are tin plating layers that cover the metal strands 11 will be described.

According to the present embodiment, the welded portions 3 are formed in the following manner, for example. First, a portion at which a welded portion 3 is to be formed is heated, and thus, the coating portions 12 of the metal warp threads 1A and the coating portions 12 of the metal weft threads 1B are melted and mixed together. At this time, the metal warp threads 1A and the metal weft threads 1B are welded at a temperature that is higher than the melting point of the coating portions 12 and lower than the melting point of the metal strands 11, for example.

Note that, according to the present embodiment, since the coating portions 12 are tin plating layers, and the metal strands 11 are made of a metal mainly composed of copper, the metal warp threads 1A and the metal weft threads 1B are heated at a temperature that is higher than the melting point (about 230 degrees) of tin and lower than the melting point (about 1080 degrees) of copper, for example. In this case, the coating portions 12 of the metal warp threads 1A and the coating portions 12 of the metal weft threads 1B are heated at a temperature that is higher than their melting point, and mixed together. Then, the thus melted and mixed coating portions 12 are solidified, so that the metal strands 11 of the metal warp threads 1A and the metal strands 11 of the metal weft threads 1B are joined together.

Moreover, according to the present embodiment, the metal strands 11 are not melted and maintain their shape. Thus, as shown in FIG. 1, in the welded portions 3, the metal warp threads 1A and the metal weft threads 1B are joined together while still maintaining the perpendicularly crossing shape.

It is also possible to partly melt the metal strands 11 of the metal warp threads 1A and the metal strands 11 of the metal weft threads 1B by adjusting the heating time and the amount of pressure applied to the metal warp threads 1A and the metal weft threads 1B. Therefore, it is also conceivable that the metal strands 11 of the metal warp threads 1A and the metal strands 11 of the metal weft threads 1B are partly melted, and the metal warp threads 1A and the metal weft threads 1B are joined together using a metal in which the melted part of the metal strands 11 is alloyed with the coating portions 12. In this case, the joining strength can be further increased.

Note that a case is also conceivable in which the metal warp threads 1A and the metal weft threads 1B are configured differently from the above-described configuration. That is to say, in the case where the metal strands 11 of the metal warp threads 1A and the metal weft threads 1B are made of a metal mainly composed of copper, it is conceivable that a metal having a lower melting point than copper is used for the coating portions 12. For example, in the case where the metal strands 11 are made of a metal mainly composed of copper, it is also conceivable, for example, that nickel plating, silver plating, or the like is used for the coating portions 12.

Moreover, as another example, it is also conceivable that the metal strands 11 of the metal warp threads 1A and the metal weft threads 1B are made of a metal mainly composed of aluminum. In this case, a lightweight sheet member 100 can be obtained. Also, at this time, it is conceivable that a metal having a lower melting point than aluminum is used for the coating portions 12. Note that the melting point of aluminum is about 660 degrees. Therefore, in this case, it is conceivable, for example, that zinc plating, tin plating, or the like is used for the coating portions 12.

Next, the wire harness 110 including the sheet member 100 will be described. Here, the wire harness 110 includes coated wires 61, terminal portions 63 including terminals and connectors, and the sheet member 100.

As shown in FIG. 2, the wire harness 110 includes a plurality of (three, here) coated wires 61. The coated wires 61 are, for example, insulated wires each including a core wire and an insulating coating that covers the circumference of the core wire. Here, terminals (not shown) are connected to the core wire at respective opposite end portions of each coated wire 61. For example, the coated wires 61 are connected to the terminals through crimping, ultrasonic welding, soldering, or the like. Note that, naturally, a case is also conceivable in which the wire harness 110 includes a single coated wire 61.

The terminal portions 63 are portions to be connected to respective counterpart members. The terminal portions 63 here each include the terminals connected to the corresponding end portions of the coated wires 61 and the connector that covers connecting portions between the end portions of the coated wires 61 and the respective terminals. The connector is a resin member, for example.

Here, it is conceivable that, in each terminal portion 63, a connector is formed around the connecting portions between the end portions of the three coated wires 61 and the three terminals connected to the respective end portions so as to collectively cover the connecting portions. That is to say, it is conceivable that the connectors in the terminal portions 63 hold, at the opposite end portions of the plurality of coated wires 61, the end portions of the coated wires 61 and the terminals in parallel with each other.

The connector of each terminal portion 63 is, for example, a portion to be fitted into a counterpart member, to which the wire harness 110 is to be connected. Note that the counterpart member may be, for example, a terminal block or the like enclosed in a metal housing. In this case, as a result of the connector being fitted into the counterpart member, the terminals are connected to the terminal block of the counterpart member, and thus, the terminal portion 63 is connected to the counterpart member.

In the wire harness 110, the sheet member 100 is used as a shielding member that covers one side of the plurality of coated wires 61. The sheet member 100 shields the plurality of coated wires 61 from electromagnetic noise. Note that, in this case, a configuration is also conceivable in which a connecting member for electrically connecting the metal housing to the sheet member 100 is connected to the sheet member 100.

Moreover, naturally, a case where two sheet members 100 are provided on one side and the other side, respectively, of the coated wires 61, a case where the sheet member 100 is folded back to cover the periphery of the coated wires 61 together, or the like is also conceivable as another configuration.

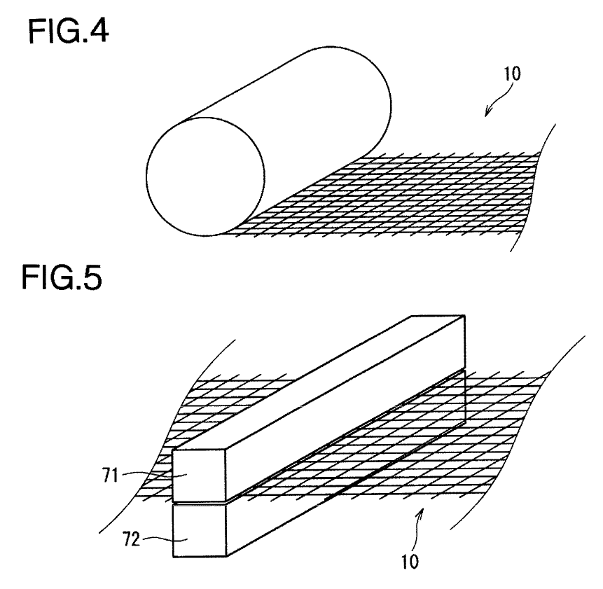

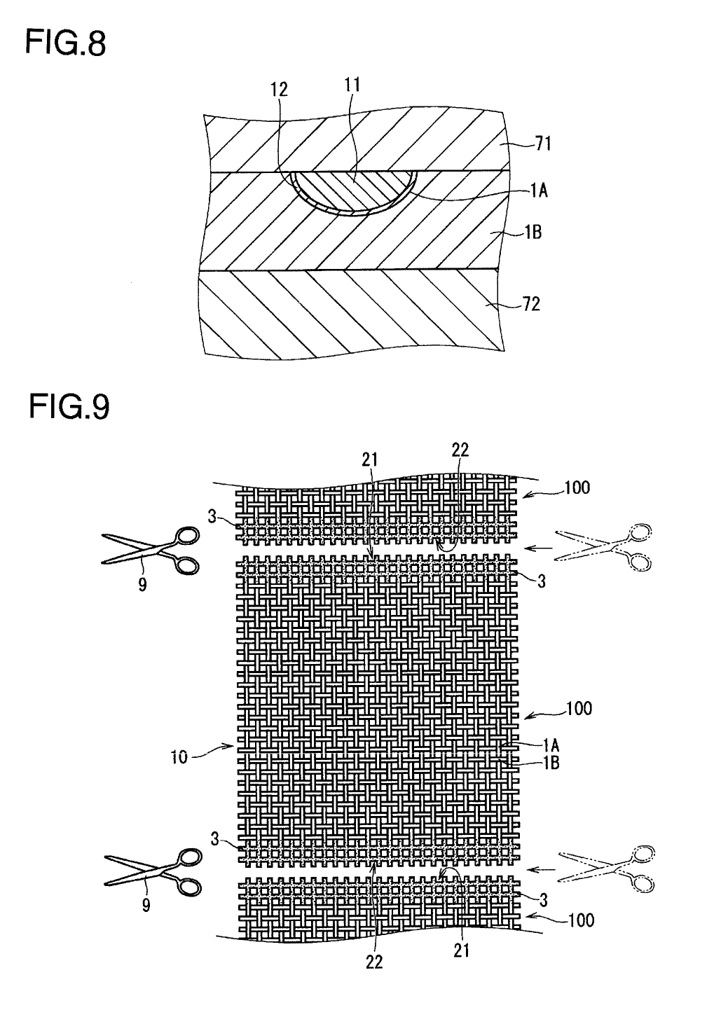

Next, with reference to FIGS. 4 to 9, a method for manufacturing the sheet member 100 (method for manufacturing a sheet member) according to the present embodiment will be described. Here, the method for manufacturing a sheet member includes a metal fabric drawing-out step, a welding step, and a cutting step. FIG. 4 is an explanatory diagram illustrating the metal fabric drawing-out step. FIGS. 5 to 8 are explanatory diagrams illustrating the welding step. Note that FIG. 8 is an enlarged view of a portion in FIG. 7. FIG. 9 is an explanatory diagram illustrating the cutting step.

In the method for manufacturing a sheet member according to the present embodiment, the metal fabric drawing-out step is a step in which a predetermined length of the metal fabric 10 is drawn out from a rolled-up raw metal fabric. As shown in FIG. 4, here, a predetermined length of the metal fabric 10 is drawn out from the raw metal fabric that has been woven from the metal warp threads 1A and the metal weft threads 1B such that the metal warp threads 1A and the metal weft threads 1B alternately cross each other and wrapped into the form of a roll in advance.

According to the present embodiment, the metal fabric drawing-out step is followed by the welding step. The welding step is a step in which heat and pressure are applied to crossing portions of the metal warp threads 1A and the metal weft threads 1B of the metal fabric 10 to weld the coating portions 12 of the metal warp threads 1A and the metal weft threads 1B together, thereby forming a welded portion 3.

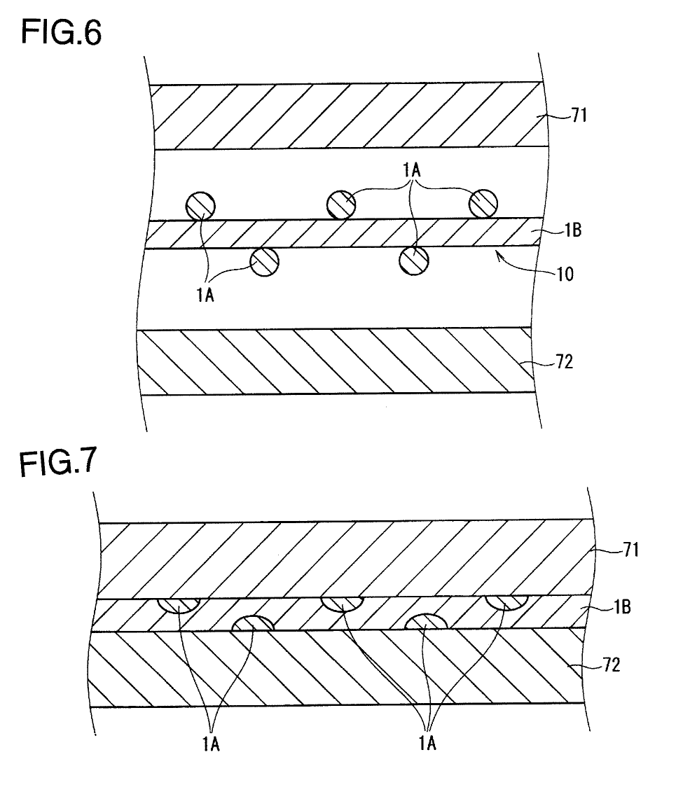

More specifically, here, as shown in FIGS. 5 and 6, an upper die 71 and a lower die 72 approach the predetermined length of metal fabric 10 that has been drawn out from the raw metal fabric. The upper die 71 and the lower die 72 will be first described.

According to the present embodiment, the upper die 71 and the lower die 72 are configured to be able to mutually approach each other, or one of the two dies is configured to be able to approach the other. The upper die 71 and the lower die 72 are configured to be able to apply pressure to a partial region, of the metal fabric 10 that has been drawn out from the raw metal fabric, in a direction in which the metal fabric 10 is drawn out from the raw metal fabric as well as the entire region of this metal fabric 10 in a width direction of the metal fabric 10 that is orthogonal to the drawing-out direction. Therefore, here, as will be described later, a welded portion 3 that is formed using the upper die 71 and the lower die 72 is formed extending across the metal fabric 10 in the width direction.

Note that, as another configuration, a case is also conceivable in which the upper die 71 and the lower die 72 are configured to be capable of processing a partial region of the metal fabric 10 in the width direction. In this case, the welded portion 3 is formed in the partial region of the metal fabric 10 in the width direction.

Moreover, the upper die 71 and the lower die 72 are configured to be able to heat the metal fabric 10. For example, the upper die 71 and the lower die 72 may be dies containing a heating mechanism such as a heater.

In the welding step here, the upper die 71 and the lower die 72 whose processing surfaces facing the metal fabric 10 are heated by a heater or the like approach the metal fabric 10 from the first main surface side and the second main surface side, respectively.

After a while, the metal fabric 10 becomes sandwiched between the upper die 71 and the lower die 72. At this time, the processing surfaces of the upper die 71 and the lower die 72 are heated to a temperature that is higher than the melting point of the coating portions 12 and lower than the melting point of the metal strands 11. That is to say, here, the processing surfaces of the upper die 71 and the lower die 72 are heated to a temperature that is higher than the melting point (about 230 degrees) of tin and lower than the melting point (about 1080 degrees) of copper.

Since the processing surfaces of the upper die 71 and the lower die 72 are heated to a temperature that is higher than the melting point of the coating portions 12, when the metal fabric 10 is sandwiched between the upper die 71 and the lower die 72, the coating portions 12 of the metal warp threads 1A and the coating portions 12 of the metal weft threads 1B, of the metal fabric 10 are melted.

Then, as shown in FIGS. 7 and 8, when pressure is further applied to the metal fabric 10 by the upper die 71 and the lower die 72 while the metal fabric 10 is being heated, the metal strands 11 of the metal warp threads 1A are embedded into the metal strands 11 of the metal weft threads 1B. Note that, at this time, the melted coating portions 12 are present between the metal strands 11 of the metal warp threads 1A and the metal strands 11 of the metal weft threads 1B.

After that, a portion of the metal fabric 10 that is sandwiched between the upper die 71 and the lower die 72 is cooled to thereby solidify the melted coating portions 12, and as a result, the metal strands 11 of the metal warp threads 1A are joined to the metal strands 11 of the metal weft threads 1B via the coating portions 12. Thus, a welded portion 3 is formed.

Note that the upper die 71 and the lower die 72 here are configured such that the distance between the processing surface of the upper die 71 and the processing surface of the lower die 72 in a state in which the upper and lower dies 71 and 72 are nearest to each other is equal to the thickness of the metal warp threads 1A (thickness of the metal weft threads 1B). Accordingly, in this case, the thickness of the formed welded portion 3 is the same as the thickness of the metal warp threads 1A (thickness of the metal weft threads 1B).

Moreover, as shown in FIG. 7, in the welded portion 3, the metal strands 11 of the metal warp threads 1A are joined to the metal strands 11 of the metal weft threads 1B in an embedded state. In this case, compared with the case where the metal warp threads 1A and the metal weft threads 1B are welded together in a point contact state, the area of contact of the metal warp threads 1A with the metal weft threads 1B is large, and therefore, the metal warp threads 1A and the metal weft threads 1B are even more firmly joined together in the welded portion 3.

Note that there is a risk that if either the metal strands 11 of the metal warp threads 1A or the metal strands 11 of the metal weft threads 1B are excessively embedded into the other, a problem such as a decrease in strength will occur. Therefore, it is preferable to perform the application of pressure in the welding step while suppressing an excessive decrease in the thickness of either the metal strands 11 of the metal warp threads 1A or the metal strands 11 of the metal weft threads 1B in the welded portion 3. Incidentally, the application of pressure in the welding step is preferably performed such that the metal strands 11 of the metal warp threads 1A and the metal strands 11 of the metal weft threads 1B in the welded portion 3 have the same thickness.

Moreover, as described above, in the case where, in the welding step, a part of the metal strands 11 is also melted, and the metal warp threads 1A and the metal weft threads 1B are joined together using a metal in which the melted part of the metal strands 11 is alloyed with the coating portions 12, the joining force between the metal warp threads 1A and the metal weft threads 1B can be further improved.

Moreover, according to the present embodiment, the welding step is performed a plurality of times, and thus, a plurality of welded portions 3 are formed at regular intervals, with respect to the above-described drawing-out direction, on the metal fabric 10 drawn out from the raw metal fabric. Then, in the subsequent cutting step, the metal fabric 10 is cut at the respective welded portions 3, and in this manner, sheet members 100 can be obtained.

According to the present embodiment, the welding step is followed by the cutting step. The cutting step is a step in which the metal fabric 10 is cut into a predetermined shape (rectangular shape, here). Note that, according to the present embodiment, the metal fabric 10 is cut at the welded portions 3 in the cutting step. Thus, sheet members 100 can be obtained.

More specifically, here, as shown in FIG. 9, the cutting step is performed using a cutting member 9 with which it is possible to cut the metal fabric 10 by moving the cutting member 9 in the width direction of the metal fabric 10. FIG. 9 shows a case where the cutting member 9 is a pair of scissors. Note that the cutting member 9 may also be a cutter or the like. Moreover, the cutting member 9 may also be a member with which it is possible to cut the metal fabric 10 by moving that member from the first main surface side to the second main surface side of the metal fabric 10.

According to the present embodiment, in the cutting step, the cutting member 9 is moved from one end portion to the other end portion of each welded portion 3 in the width direction of the metal fabric 10 to thereby cut the metal fabric 10 at that welded portion 3. Note that, here, as shown in FIG. 9, a portion between two adjacent welded portions 3, of the metal fabric 10 drawn out from the raw metal fabric constitutes a sheet member 100. Therefore, here, a single sheet member 100 can be obtained by cutting the metal fabric 10 drawn out from the raw metal fabric at each of the two adjacent welded portions 3.

Note that, according to the present embodiment, the metal fabric 10 is separated into two pieces as a result of being cut at a single welded portion 3. At this time, the welded portion 3 is also separated into two parts, and each part of the welded portion 3 constitutes an outer edge portion on a cut portion side of two pieces of metal fabric 10. That is to say, here, one of the two parts of the welded portion 3 separated in the cutting step constitutes the first outer edge portion 21 of a single sheet member 100, and the other part constitutes the second outer edge portion 22 of another sheet member 100 different from the single sheet member 100.

Therefore, it is conceivable that, in the cutting step, the metal fabric 10 is cut at an intermediate position of the welded portion 3 in the above-described drawing-out direction. It is preferable that the metal fabric 10 is cut at the middle of the welded portion 3 in the drawing-out direction. The reason for this is that the welded portions 3 in the two pieces of metal fabric 10 after cutting have the same dimensions.

Moreover, in the cutting step of the present embodiment, since the metal warp threads 1A and the metal weft threads 1B are joined together in each welded portion 3, it is possible to suppress fraying of the metal warp threads 1A and the metal weft threads 1B at the cut portion.

Moreover, according to the present embodiment, in each welded portion 3, the metal warp threads 1A and the metal weft threads 1B are joined together while still maintaining the perpendicularly crossing shape. In this case, as shown in FIG. 9, the metal warp threads 1A can be individually cut during the cutting operation, so that the force necessary for cutting can be reduced, and the ease of operation of the cutting operation can be improved.

Moreover, according to the present embodiment, it is conceivable that a single welding step and a single cutting step are performed as a single set, and this set is performed a plurality of times to thereby obtain a plurality of sheet members 100. However, for example, a case is also conceivable in which, after all of the plurality of welding steps have been performed, all of the cutting steps are performed at respective welded portions 3 to thereby obtain a plurality of sheet members 100.

### Effects

According to the present embodiment, the sheet member 100 includes the welded portions 3 where the coating portions 12 of the metal warp threads 1A and the metal weft threads 1B are joined together at crossing portions of the metal warp threads 1A and the metal weft threads 1B. In the sheet member 100 in this case, the metal strands 11 of the metal warp threads 1A and the metal strands 11 of the metal weft threads 1B are joined together via the coating portions 12. Thus, the metal warp threads 1A and the metal weft threads 1B of the metal fabric 10 can be even more firmly joined together.

Also, according to the present embodiment, the welded portions 3 are provided at the outer edge portions (here, the first outer edge portion 21 and the second outer edge portion 22) of the sheet member 100. In this case, the welded portions 3, which are provided at the first outer edge portion 21 and the second outer edge portion 22, can suppress the spread of fraying of the metal warp threads 1A and the metal weft threads 1B.

Moreover, according to the present embodiment, the sheet member 100 includes the four straight line-shaped outer edge portions (here, the first outer edge portion 21, the second outer edge portion 22, the third outer edge portion 23, and the fourth outer edge portion 24), and the welded portions 3 are provided at the two opposing outer edge portions (here, the first outer edge portion 21 and the second outer edge portion 22) of the four outer edge portions. In this case, the shapes of the first outer edge portion 21 and the second outer edge portion 22 at which the welded portions 3 are formed are fixed, and thus, the sheet member 100 is less likely to deform in a direction that crosses the direction in which the first outer edge portion 21 and the second outer edge portion 22 oppose each other.

Moreover, according to the present embodiment, the welded portions 3 are formed by performing welding at a temperature that is higher than the melting point of the coating portions 12 and lower than the melting point of the metal strands 11. In the welded portions 3 in this case, the metal strands 11 are not completely melted, and thus, the crossing shape of the metal warp threads 1A and the metal weft threads 1B is maintained. Therefore, according to the present embodiment, it is possible to join the metal warp threads 1A and the metal weft threads 1B together via the coating portions 12 while maintaining the shape of the metal strands 11 of the metal warp threads 1A and the metal weft threads 1B.

Moreover, according to the present embodiment, the thickness of the welded portions 3 is the same as the thickness of the metal warp threads 1A alone and the thickness of the metal weft threads 1B alone. In this case, the welded portions 3 can be suppressed from becoming excessively thick compared with the other portions of the sheet member 100.

Moreover, according to the present embodiment, the metal strands 11 are strands made of a metal mainly composed of copper, and the coating portions 12 are tin plating layers that cover the respective metal strands 11. In this case, the metal strands 11 of the metal warp threads 1A and the metal weft threads 1B can be joined together via the tin plating layers.

Moreover, according to the present embodiment, the sheet member 100 is obtained by cutting the metal fabric 10 at the welded portions 3, and fraying of the woven metal warp and weft threads 1A and 1B during cutting can therefore be suppressed.

Furthermore, according to the present embodiment, the metal strands 11 in the welded portions 3 are not completely melted, and thus, the crossing shape of the metal warp threads 1A and the metal weft threads 1B is maintained. Therefore, the cutting operation can be performed with ease.

Moreover, in the case where the metal fabric 10 is cut at the welded portions 3, the shape of the sheet member 100 that has been cut at the welded portions 3 can be suppressed from significantly deforming from the shape of the metal fabric 10. Therefore, for example, in the case where the sheet member 100 is used as a shielding member of the wire harness 110, the shape of the sheet member 100 can be made closer to a required shape. The reason for this is that fraying of the woven metal warp and weft threads 1A and 1B during cutting and resulting deformation of the shape of the sheet member 100 can be suppressed.

### First Modification

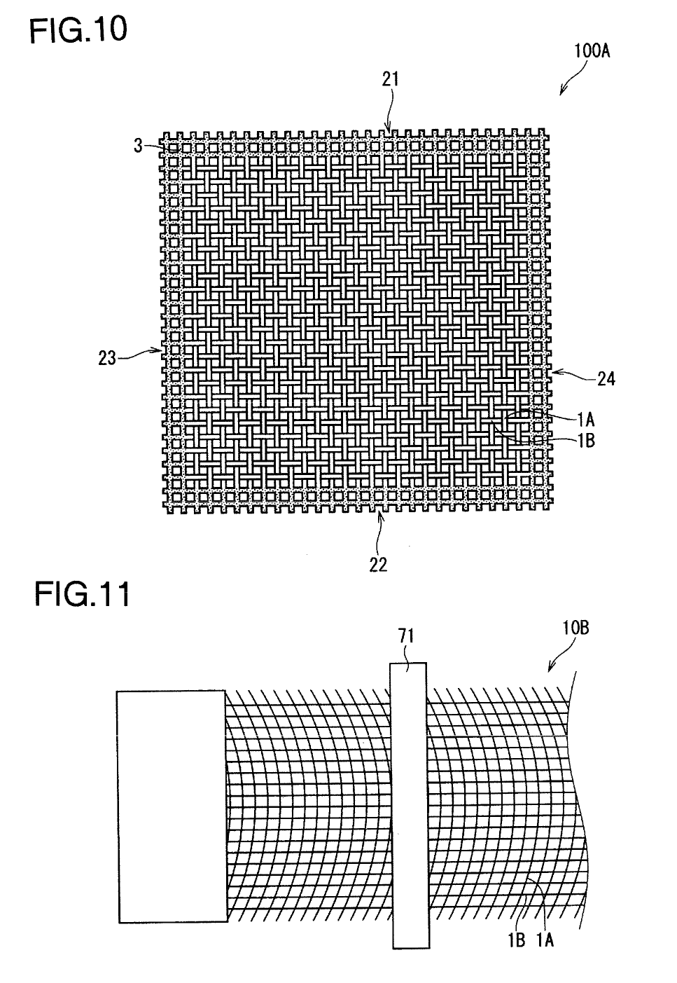

Next, with reference to FIG. 10, a sheet member 100A according to a first modification will be described. FIG. 10 is a plan view of the sheet member 100A. Note that, in FIG. 10, constituent elements that are the same as those shown in FIGS. 1 to 9 are denoted by the same reference numerals.

As is the case with the foregoing embodiment, the sheet member 100A of the present example also includes the first outer edge portion 21, the second outer edge portion 22, the third outer edge portion 23, and the fourth outer edge portion 24. However, unlike the foregoing embodiment, in the sheet member 100A of the present example, a welded portion 3 is formed at all of the outer edge portions. That is to say, as shown in FIG. 10, the welded portion 3 is formed at the above-described four outer edge portions (the first outer edge portion 21 to the fourth outer edge portion 24). In this case, deformation of the sheet member 100A can be suppressed even more effectively.

### Second Modification

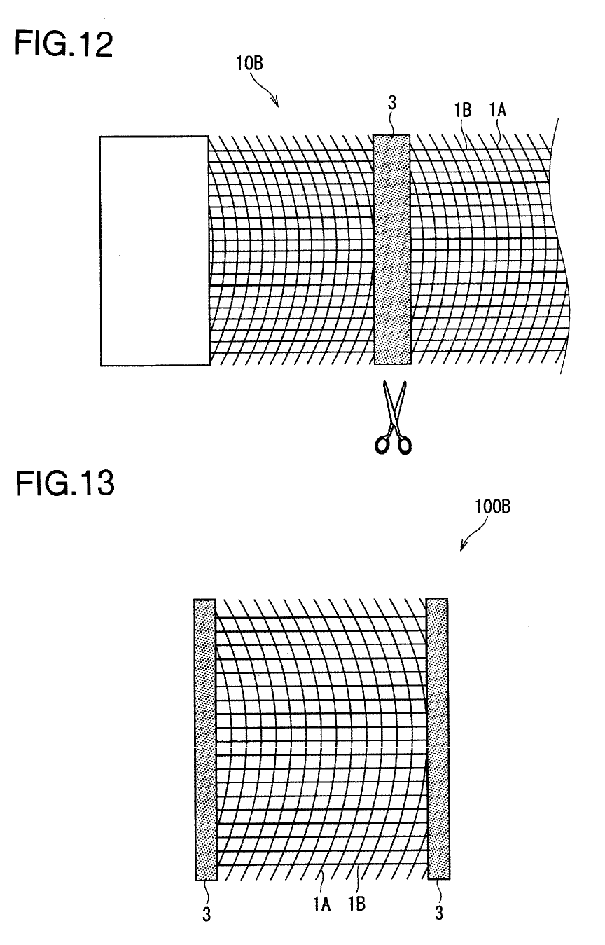

Next, with reference to FIGS. 11 to 13, a sheet member 100B according to a second modification will be described. FIGS. 11 and 12 are diagrams for explaining a method for manufacturing the sheet member 100B. FIG. 11 illustrates the welding step, and FIG. 12 illustrates the cutting step. Moreover, FIG. 13 is a plan view of the sheet member 100B. Note that in FIGS. 11 to 13, constituent elements that are the same as those shown in FIGS. 1 to 10 are denoted by the same reference numerals.

According to the present example, as shown in FIG. 13, in the welded portions 3 and portions other than the welded portions 3, the metal warp threads 1A of the sheet member 100B cross the metal weft threads 1B in a state in which the metal warp threads 1A are bent.

As shown in FIGS. 11 and 12, the above-described shape is formed as a result of the metal warp threads 1A of a metal fabric 10B bending due to the force by which the metal fabric 10B is drawn out from the raw metal fabric.

That is to say, in the present example as well, in the state in which no external force is applied, the metal warp threads 1A perpendicularly cross the metal weft threads 1B as in the foregoing embodiment. However, as shown in FIGS. 11 and 12, in a predetermined length of metal fabric 10B that has been drawn out from the rolled-up raw metal fabric, the metal warp threads 1A are bent so as to protrude from the upstream side toward the downstream side in the drawing-out direction due to the drawing force.

Then, in the welding step of the present example, as shown in FIG. 11, hot pressing is performed while the metal warp threads 1A remain in the bent state. Consequently, as shown in FIG. 12, a welded portion 3 where the metal warp threads 1A and the metal weft threads 1B are welded together is formed while the metal warp threads 1A remain in the bent state.

After that, as shown in FIG. 12, the cutting step is performed in which the metal fabric 10B is cut at the welded portion 3. In the metal fabric 10B that has been cut at the welded portion 3, the welded portion 3, where the metal warp threads 1A are welded to the metal weft threads 1B while remaining in the bent state, constitutes an outer edge portion on a cut portion side.

Here, if the metal fabric 10B is cut in a state in which no welded portion 3 is formed, it is considered that the metal warp threads 1A having the bent shape may return to their original straight line shape (shape that perpendicularly crosses the metal weft threads 1B). However, if the metal warp threads 1A return to their original shape, a problem such as a change in the shape of the cut portion may occur. For example, a problem may occur in that, after the metal fabric 10B has been cut in the direction that is perpendicular to the drawing-out direction of the metal fabric 10B, the metal warp threads 1A will return to their original shape, and the outer edge portion on the cut portion side will be curved or skewed.

On the other hand, according to the present example, since the metal warp threads 1A are welded to the metal weft threads 1B in a state in which the metal warp threads 1A are bent, and fixed in this shape, when the metal fabric 10B is cut at a welded portion 3, deformation of the shape of the cut portion is suppressed. Therefore, in the present example, the effect of the bent state of the metal warp threads 1A of the metal fabric 10B on the shape of the metal fabric 10B after cutting can be reduced, and consequently, a sheet member 100B having a shape that is closer to a required shape can be produced.

### Application Examples

With respect to the sheet member 100, a case where a welded portion 3 is formed over the entire periphery of an outer edge portion, a case where a welded portion 3 is formed in a partial region of an outer edge portion in a peripheral direction, or the like is conceivable. Moreover, a case where a welded portion 3 is provided at a portion other than the outer edge portions, for example, a central portion, is also conceivable.

According to the foregoing embodiment, the cutting step is performed after the welding step. However, a case where the cutting step is performed prior to the welding step is also conceivable. In this case as well, fraying of the metal warp threads 1A and the metal weft threads 1B can be suppressed after welding, and the metal warp threads 1A and the metal weft threads 1B of the metal fabric 10 can be even more firmly joined together.

Moreover, a case where the coating portions 12 are made of a material other than metal is also conceivable. That is to say, a case where the coating portions 12 are made of a resin that covers the outer circumferential surface of the metal strands 11 and other cases are also conceivable. Note that in the case where the metal strands 11 are made of copper, a resin having a melting point that is lower than about 1080 degrees is preferably used, and in the case where the metal strands 11 are made of aluminum, a resin having a melting point that is lower than about 660 degrees is preferably used. For example, it is conceivable that a fluororesin such as polytetrafluoroethylene, which has a melting point of about 330 degrees, is used for the coating portions 12.

Note that a sheet member and a method for manufacturing the sheet member according to the present invention can also be configured by freely combining the embodiment, the modifications, and the application examples that have been described above or by appropriately modifying, or omitting a portion of, the embodiment, the modifications, and the application examples, without departing from the scope of the invention as defined in the claims.

### LIST OF REFERENCE NUMERALS

10 Metal fabric

100 Sheet member

11 Metal strand

12 Coating portion

1A Metal warp thread

1B Metal weft thread

3 Welded portion

1. A sheet member formed from a metal fabric that is woven from metal warp threads and metal weft threads such that the metal warp threads and the metal weft threads alternately cross each other, the metal warp threads and the metal weft threads each including a linear metal strand made of a metal and a coating portion that covers a circumference of the metal strand, the sheet member comprising:
a welded portion in which the coating portions of the metal warp threads and the coating portions of the metal weft threads are welded together at crossing portions of the metal warp threads and the metal weft threads.

2. The sheet member according to claim 1,
wherein the welded portion is provided at an outer edge portion.

3. The sheet member according to claim 2, further comprising:
four straight line-shaped outer edge portions,
wherein the welded portion is formed at two opposing outer edge portions of the four outer edge portions of the metal fabric.

4. The sheet member according to claim 1,
wherein the welded portion is formed by performing welding at a temperature that is higher than a melting point of the coating portion and lower than a melting point of the metal strand.

5. The sheet member according to claim 1,
wherein a thickness of the welded portion is the same as a thickness of the metal warp threads alone and a thickness of the metal weft thread's alone.

6. The sheet member according to claim 1,
wherein the metal strand is a strand made of a metal mainly composed of copper, and
the coating portion is a tin plating layer that covers the metal strand.

7. A method for manufacturing a sheet member formed from a metal fabric that is woven from metal warp threads and metal weft threads such that the metal warp threads and the metal weft threads alternately cross each other, the metal warp threads and the metal weft threads each including a linear metal strand made of a metal and a coating portion that covers a circumference of the metal strand, the method comprising:
applying heat and pressure to crossing portions of the metal warp threads and the metal weft threads of the metal fabric to weld the coating portions of the metal warp threads and the metal weft threads together, thereby forming a welded portion; and
cutting the metal fabric into a predetermined shape.

8. The method for manufacturing a sheet member according to claim 7,
wherein the metal fabric is cut at the welded portion to thereby obtain the sheet member.

9. The method for manufacturing a sheet member according to claim 7,
wherein the welded portion is formed through heating at a temperature that is higher than a melting point of the coating portion and lower than a melting point of the metal strand.
